(19) United States
(12) Patent Application Publication
(10) Pub. No.: US 2002/0108000 A1
(43) Pub. Date: Aug. 8, 2002

(54) User recognition system for automatically controlling accesse, apparatuses and the like equipment

(76) Inventors: Marco Iori, Padova (IT); Marco Mescalchin, Campodarsego (IL); Nicola Gugliemo, Monselice (IT)

Correspondence Address: BIRCH STEWART KOLASCH & BIRCH, PO BOX 747, FALLS CHURCH, VA, 22040-0747, US

(21) Appl. No.: 10/019,780

(22) PCT Filed: May 2, 2001
(86) PCT No.: PCT/EP01/04912

(30) Foreign Application Priority Data
May 4, 2000 (IT) PD2000A000114
Aug. 4, 2000 (IT) UD2000A000148

(51) Int. Cl. G06F 3/00

(52) U.S. Cl. 710/11

(57) ABSTRACT

A user recognition system for automatic managing of accesses, the use of equipment, handling of goods or enjoying of services, including at least one central processor (2, 15), at least one peripheral unit (4, 11) with at least one detecting device (12) for detecting biometric data relating to the physical characteristic features identifying a user, wherein each peripheral unit (4, 11) is connected through at least one interface unit (5, 17) to said central processor (2, 15) by means of a communication network, and that each peripheral unit (4, 11) have at least one electronic card (14) suitable for permitting two-way transmission of biometric data acquired from said detection means (12) to said central processor (2, 15), through at least one interface unit (5, 17) acting as a network card and interface between a port (19) of said central processor (2, 15) and said communication network

### FIELD OF APPLICATION

This invention relates to an integrated user recognition system suitable for automatic access management and customised use of apparatuses, dispensers, services, goods and the like.

More particularly, the present invention can be applied to an essentially unlimited number of applications and is suitable for use in the formation and management of a user archive, the management of production flows, databases, remote-controlled payments, electronic signature and the like.

### BACKGROUND OF THE INVENTION

Problems to be faced in the production and management of customised access systems for providing access only to authorised, ticket holding or somehow recognized persons to public business or premises, offices, hospitals and transport means, e.g. underground, trains, and the like are well known.

Current registration methods often involving paper work possibly coupled with magnetic identifying cards (e.g. badges for offices and factories or debit card for access to credit services), frequently involve inefficiencies, slackness in the search, taking of substantial archive space, data recovery difficulties and still further problems such as the need for the presence of at least one operator.

In certain protected areas like banks, automatic biometric recognition systems have already been proposed for identification of some physical characteristics of the user, such as finger prints or retina recognition.

See, in this concern, international patent application WO00/42577 (Sensar, Inc.), which, however, is aimed at preventing hackers from getting hold of data transmitted from a biometric sensor on its path to a server to be used subsequently for fraudulent purposes, international patent application WO 99/16025 (Raytheon Company), that discloses processing and storing in a terminal biometric data picked up by the terminal itself, i.e. a stand-alone type terminal, and U.S. Pat. No. 6,070,796 (Sirbu) that discloses a pointing device of mouse trackball type or the like provided with a slot for inserting a card including a microchip in which a code is memorised to which biometric data detected by a finger print sensor are compared, with no data being transmitted through the network or processed in the PC.

In general, these are systems include data reading means provided on entirely integrated electronic cards, an inner microprocessor to process the data thus collected and an integrated memory in the reading means itself for storing such data.

Moreover, such systems have the disadvantage of being expensive to produce, as each reading means is a substantially complete unit with its own processing unit and its own memory means. At the same time, the memory capacity of every such means is limited, thereby preventing, unless one is dealing with most highly evolved and costly models, recording more than 5,000 user's prints (normally of 2,500 users). Moreover, data working and self-synchronisation speed among several detectors linked to each other in a network generally through an RS485 serial line cannot be very high as the whole data acquisition, comparison and possible recording stage is carried out by each individual reading means and interfacing with a central unit occurs in a passive way, normally through a very slow serial line of RS232 type only for data report.

This solution, therefore, has the drawback of using a huge amount of resources since each reading unit must be equipped with its own processing and storing means for data saving and with self-synchronization capacity for data transfer to each reading unit in the network. Should data stored in each reading unit be saved, instead, on the hard disk of the server, the limitation of establishing. an interactive and personalized data flow through sufficiently wide band communication lines between reading unit and server would still remain. As a matter of fact, owing to the above mentioned structure a bottle neck would be the low serial line, in general a RS232 line, between server and reading units normally connected to each other by way of a serial line RS485.

Other systems which use biometric data for identifying a user are the smart cards. This solution makes it possible to register biometric data, e.g. a finger print, on a microchip in a card. Such a card, when inserted in a suitable apparatus having a finger print reader, allows data stored in the card to be compared with those acquired by the finger print reader itself. The disadvantage of such a solution is that in any case the card is not eliminated and an hacker could provide himself with a smart card and enable it with his own finger prints.

Further reading systems have been suggested that control, through finger print recognition, access to a personal computer and/or enable use of its respective keyboards in order to avoid the use of inconvenient passwords. These systems are specifically dedicated to such a function. Data transmission thus takes place through a parallel or USB gate, but only very limited distances of no more than about 5 m can be covered. This makes such systems unsuitable for uses such as access management or use of equipment in public places and undertakings.

### SUMMARY OF THE INVENTION

The main object of the present invention is to substantially eliminate the above drawbacks, thereby attaining the advantages referred to hereinbelow.

Another object of the present invention is to provide an integrated user recognition system suitable for managing or controlling customised accesses to places, equipments, information, graphic animation, files and the possibility of handling goods, services and money and for operating a substantially unlimited number of users at a very reduced production, installation and running costs, owing to very low overall energy consumption.

Another object of the present invention is to avoid any additional cost, both for the manager and the user, for acquiring a magnetic card or the like means of identification.

Another object of the present invention is to provide a integrated system of modular type, both so far ad hardware and software is concerned, that can be extended and implemented at any time depending upon the changing needs to be faced by the public place or undertaking where it is used.

A further object of the present invention is to eliminate the need for any recognition means, e.g. an electronic card or the like, which is liable to be left behind, to be lost or to become demagnetised and normally requires storing of a personal identification code (PIN).

A further object of the present invention is to ensure very easy installation of the biometric reading terminals and very easy configuration of network addresses (ip addresses) in each terminal for obtaining a local communication network.

Not last object of the present invention is to make it possible for a manager of a public commercial concern or of a good distributor or service supplying concern to process data acquired from users in order to carry out statistics, time analysis, accountancy studies and the like and to make them available on the acquisition terminal in real time on the same network in a highly personalized manner; the same data can be further personalized through control of any keyboard or display connected to the acquiring terminal.

According to the present invention there is provided a recognition system as defined in the main claim.

Owing to the setting up of a two-way flow of information between an acquiring data unit and a central processor, such as a PC or a server, the present invention allows biunique management to be conducted, through biometric recognition, of a piece of data or flow of customised data integrated into a system and supplied on a large scale in real time, unobstructed access is possible with absolute certainty and security being possible at very low production and running costs.

According to the invention, by using automatic biometric recognition of an identifying physical characteristic of a user, possibly linked to keying of personal data or code on a keyboard, customised handling of a plurality pieces of equipment, dispensers or services is made possible.

In the case of use of goods or services, user recognition may be linked to possible automatic billing or in the case of an integrated terminal connected to internet to an automatic configuration of the electronic post account or the like.

The system according to the invention is based on biometric recognition of a physical characteristic of the user. In the following detailed description an embodiment will be described of a system which effects users' finger print recognition. The present invention is not, however, limited to it, but includes also equivalent solutions that provide recognition of other users distinctive physical characteristics, such as the retina of the eye, voice, features of the face or a combination thereof.

Such a system comprises one or more units connected to one another in a communication network to at least one central processor. Such a communication network must have such a passing band as to make it possible a transmission speed of at least 1 Mbps and should include such a wiring as to obtain a quite economic network in so far as both installation and maintenance are concerned.

According to a preferred solution, such a network advantageously is an Ethernet (IEEE 802.3) wiring or e mixed RS485/Ethernet network or other mixed solutions, such as RS485 interfaced with USB gates or parallel gates of the used computer, a Canbus network, a digital telecommunication network , e. g. according the bluetooth standard. Moreover, by using geographical wiring that will be available very soon, use can be made of ethernet networks to set in communication the various local networks. This makes it possible to process acquired and transmitted data in real time and to acquire a rapid and coherent data exchange between the periphery (biometric data detector) and central unit (network server or local processor of a host computer network).

Moreover, by using as communication protocol the TPC/IP protocol suite on a quick physical network, data are immediately and simultaneously made available to the acquisition process by the biometric data detector. Thus, two processes (scanning and data sending to the central processor) are simultaneously controlled. A highly powerful and efficient processor, e.g. a server for processing data from peripheral terminals, is used. In this way, data scanning and transmission times to the processor are superimposed without being added up, thereby obtaining extremely reduced data scanning, acquisition, sending and processing times that are more advantageous with respect to those of a stand alone processor which includes a lass powerful processor with respect to that of a server and does not employ parallel or simultaneous processes.

According to an important characteristic of the present invention each peripheral unit has at least one detecting or sensing means for detecting biometric data of a users physical characteristic to be recognized, e.g. finger print, retina, voice and/or features of the face and at least one electronic card for the acquisition of data detected by the said detecting means and their transmission to the central processor.

According to another advantageous embodiment, the said electronic card is also suitable for compressing data detected by the said detecting means in order to obtain a higher transmission speed.

Between each peripheral unit and its respective central processor at least one interface unit or network card is provided, which is suitable for connecting the said central processor to the Ethernet or serial network to which the peripheral units are connected.

According to a first embodiment, the network card is an Ethernet card. According to another embodiment, the processor gate connected to the network through a specific serial-line network interface is a USB or parallel gate.

According to another advantageous solution, the network card is a Canbus card, whereas according to a another solution, the network card is a bluetooth card or radio card.

The electronic card associated with each of the peripheral units is suitable for managing a two-way data flow at a wide band (1 Mbs), through the said network and its respective interface by means of a corresponding central processor. Such an electronic card is also suitable for running communication with a keyboard and a respective alphanumeric or graphic display.

In view of the above, any information relating to a specific user acquired by the detecting unit, both for its first recording and on subsequent comparisons and possible recognition, is transferred in a substantially simultaneous way to the central processor that becomes in this way interactive with its respective peripheral units.

The presence of the interface, that permits wide-band data processing, makes it possible two-way data flow in real time, even on a large scale, e. g. on the Internet network.

Upon receiving such a flow of information, the central processor processes and stores the user's identifying and characteristic features in code form having an extremely reduce dimension, of the order of about a few hundreds of bytes (generally from 200 to 300 bytes).

This code is then saved on the central processor hard disk and any additional not indispensable information is deleted, also protecting the individual users privacy since it is not possible to trace back to the print, and this also for safeguarding user's privacy as from such a code it is no longer possible to identify the print, and thus the user that has generated it

With this solution the advantage is attained of transferring of the whole customers (users) archive from the individual terminals, as it occurs at the present time, to a central processor that, thanks to data codification, is adapted to store information on a substantially unlimited number of users, whose identity depends only on the size of the mass storage of the server.

Moreover, even in those cases where the reading terminal automatically processes the biometric data and transfer the generated print code directly onto the hard disk of the central server according to structures used at present by using large-band communication lines, it would be possible to generate in any case a two way data flow sufficiently wide as to make it possible to exchange and share resources, such as web , pages, audio files, video files or the like in real time made interactive by display and keyboards. As a matter of fact, the present structures include very slow communication channels between server and peripheral reading terminals, such as serial RS232.

The use of a data acquisition and transmission card associated with each peripheral unit and the presence of interface units suitable to simultaneously manage several data detecting units makes it possible to establish a network connection among various groups or modules of peripheral units even arranged at a distance from one another of the order of 1 km, a distance that can be increased by using suitable amplification systems.

The system according to the present invention, besides using a local dedicated network, can also be used on internet network to allow a registered user, through acquiring and sending his identification code, to carry out at distance purchasing, renting operations of goods or services. In this case, each peripheral unit can be set up to send, via its respective local central processor or directly through an integrated modem, a piece of biometric data in tcp/ip network to a remote processor and exchange with it customised two-way information in real time.

### BRIEF DESCRIPTION OF THE DRAWINGS

Further aspects and advantages of the present invention can be better appear from the following description of some embodiments thereof given merely by way of non-limiting examples, with reference to the accompanying drawings, in which:

FIG. 1 shows a flow chart of a user identification system according to the present invention;

FIG. 2 illustrates a preferred embodiment of the identification system according to the present invention;

FIG. 3 shows a variation of the embodiment of FIG. 2;

FIG. 4 shows another variation of the embodiment of FIG. 2;

FIG. 5 illustrates a further variation of the embodiment of FIG. 2; and

FIGS. 6 and 7 show two further embodiments of present invention.

### Detailed DESCRIPTION OF THE PREFERRED EMBODIMENTS

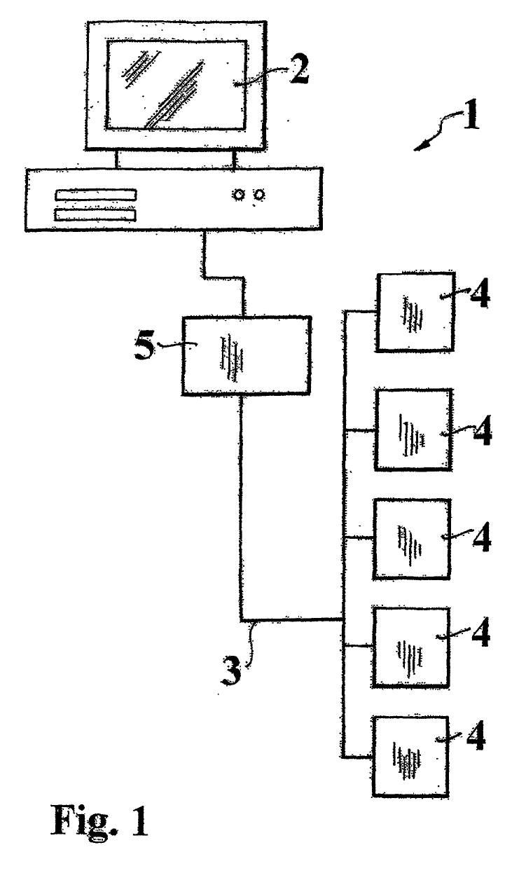

With reference first to FIG. 1, a system particularly for automatic management of accesses and/or equipment in public commercial concerns, sport centres, offices, factories and the liker, according to the present invention, is generally indicated with the numeral 1. More particularly, the system 1 comprises a processing unit 2, typically a personal computer, in which there is implemented, besides a server-type management operating system, a customer archive with respective identification details. The processing unit 2 is connected by way of a network connection 3 to a plurality of user's biometric print detecting/identification devices, all indicated with 4 and adapted to provide a customized service to the customer in real time after the customer has been recognized, possibly through an interface parallel/serial or USB/serial converter 5. More particularly, the network connection 3 can be a serial port of RS485 type and thus the network of the serial port 3 can be a high speed serial network.

The system shown in FIG. 1 also illustrates a further embodiment of the present invention, where, if the network connection 3 comprises an Ethernet hub and the connection between the hub 3 and each device 4 is an Ethernet connection (either directly through optical fibre, with multipair cable or coaxial cable), an ethernet is available having a transmission speed surely higher than 1 Mbps, thereby ensuring that customer's requests are met in real time.

FIGS. 2 to 7 illustrate an integrated users identification system in accordance with the present invention generally indicated with the reference numeral 10 and comprising a plurality of peripheral units 11, each provided with at least one sensor 12, that can be of any suitable type, e.g. a finger print (13) recognizer , retina recognizer, voice print recognizer or face recognizer.

According to a specific embodiment, sensor 12 comprises a silicon microchip associated with a surface on which the user places his finger 13. The microchip is adapted, through processing by means of a suitable dedicated recognition software, to create a digital profile corresponding to the user's print and convert it into a video signal with a resolution up to about 500 dpi.

Each peripheral unit 11 has an electronic data acquisition and control card 14 which is suitable for two-way communication of data acquired by the sensor 12 with a central processor 15, to which a plurality of peripheral units 11 are connected. This two-way communication occurs via a synchronous serial cable 16, e.g. using RS485 communication standard, that allows data to be transmitted at 10 Mbps for distances up to 400 m, or at 2 Mbps for distances up to about 1.2 km.

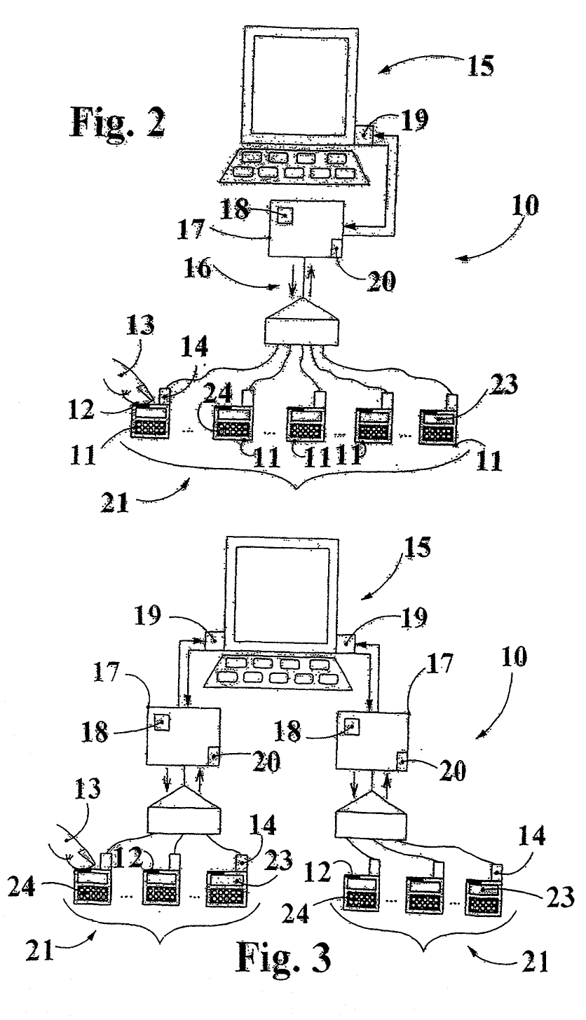

Connection between serial cable 16 and central processor 15 occurs through interface 17 having at least one chip 18 of RS485 standard which in its standard configuration is suitable for running up to 32 peripheral units 11 (FIG. 3). Interface 17 is designed to establish connection between cable 16 and a USB port, or a parallel port 19 of the central processor 15, thus establishing a two-way connection between each peripheral unit 11 and the processor 15 that becomes then continuously and fully interactive with the data acquiring units. More particularly, interface 17 is a network card suitable for managing biometric data from one or more sensors 12 in respective peripheral units 11 and generic file or text data.

In this way, owing to the presence of data acquiring and control card 14, information relating to each individual user, as acquired by sensor 12, is transferred in a substantially simultaneous way and via said interface 17 to the central processor 15, inside which the whole archive of the customers of the business, where the system 10 is installed, is stored. The central processor 15 processes the data, and more particularly generates an identification code of about 200-300 bytes, from each acquired print. If desired, It also carries out a comparison with the data already stored in the archive.

The wide band (1 Mbps) used for the data transmission makes it possible for the central processor 15 to become fully interactive with its respective peripheral units 11. Thanks to the codification of the acquired and stored data, it is possible to build a practically unlimited data archive whose capacity of the hard disk in the central processor 15.

Interface 17, that can also include a buffer 20 for running data transmission between the data collection cards 14 and the central processor 15 and for management of multiple connection and data transfer requests, can handle with one chip 18 in standard configuration up to 32 peripheral units 11.

Should it be necessary to connect a greater number of peripheral units, the configuration in FIG. 3 can still be used by connecting the blocks 21, each of 32 peripheral units, to a respective interface 17, which is connected in turn to a second USB-or parallel port 19 of the central processor 15.

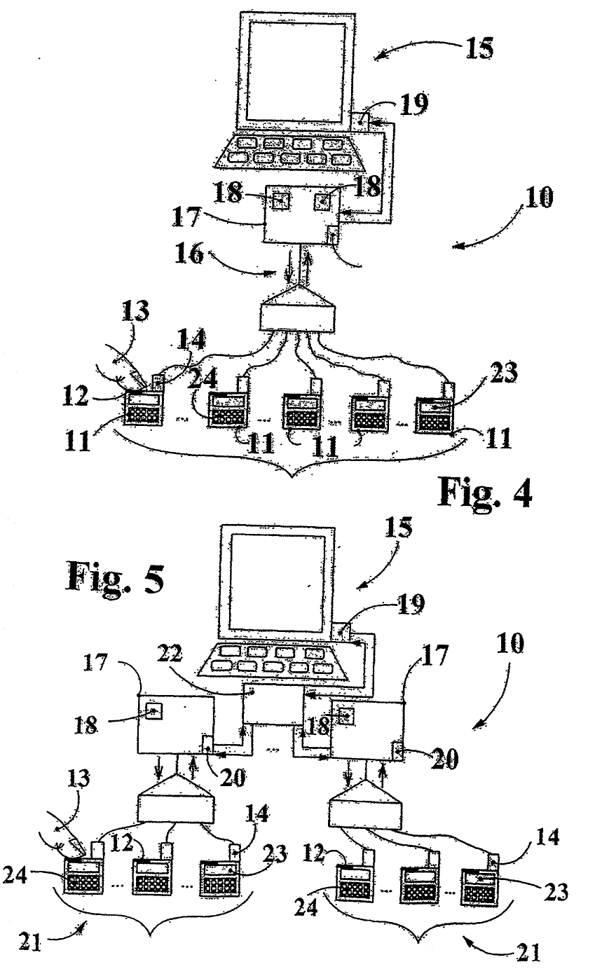

The further variation illustrated in FIG. 4 provides the connection of 64 peripheral units 11 thanks to the use of an interface 17 equipped with two RS485 standard chips 18.

According to the modification illustrated in FIG. 5, two or more connection interfaces 17, each with its respective chip 18, are connected to a hub 22 that sorts then the data for the central processor 15.

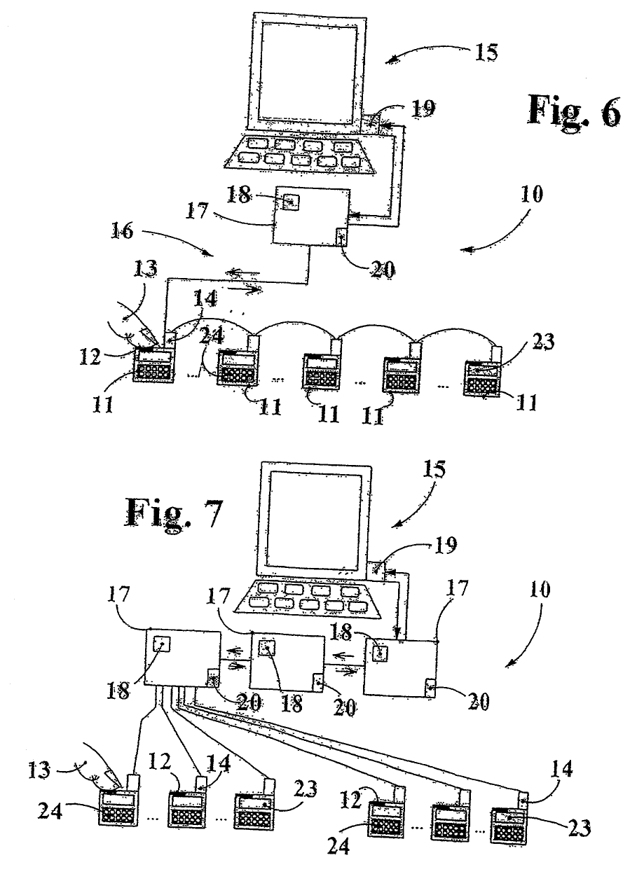

Another solution, illustrated in FIG. 6, provides a plurality of interfaces 17 connected one another in cascade, only the last interface 17 in the chain being connected to a port 19 at the central processor 15.

According to yet another embodiment illustrated in FIG. 7, a plurality of interfaces 11 are connected to one another in cascade and then to the interface 17 that establishes communication with the central processor 15.

With reference still to FIG. 6, according to a further modification of the present invention there is provided that the server 15 is connected through an Ethernet network card 17 to a presence detecting terminal 11 provided with Ethernet/RS485 interface. From this first terminal a cascade serial RS485 connections starts, which makes it possible to connect a high number of terminals 11 in cascade to the previously described terminal. Such an embodiment allows mixed networks to be obtained which through a terminal with an Ethernet interface directly connected to the server 15 or a hub 22, as shown in FIG. 5, make it possible to connect to the server 15 a number of cascades of terminals 11 equal to the number of port available on each hub 22 and ensures that each cascade of terminals 11 establishes inside thereof communications with a high-speed synchronous serial protocol and communicates with the server 15 with the same protocol or the TCP7IP network protocol.

With these variations that do not embrace any possible network configuration that could be obtained with such a basic structure of the system, the number of peripheral units 11 that can be connected to the a central processor 15 can be extended practically with no limit, thanks both to the possibility of inserting further connection interfaces 17 in the network; each provided with a desired number of chips 18, and to the capacity of each USB or parallel port 19 of the central processor 15 to hold up to 127 interfaces 17 in a network.

From the above it can be noted that the use of a data acquiring and control card 14 associated with each peripheral data acquisition unit 11 makes it possible to transfer to the central processor 15 the whole handling of the customer archive, thereby reducing the working load of each unit 11. In this way, the memory capacity and processing speed can be increased substantially with no limit In addition, data can be managed in a TCP/IP network, by advantageously using an Ethernet-type or RS485 transmission standard.

The use of suitable processing and management software allows acquired data to be compressed already in the peripheral units 11, thereby reducing the volume of data transmitted and thus increasing speed. The encoding carried out by the central processor 15 allows memory space required for storing the data on a specific user to be reduced to a minimum. Such an encoding makes also possible to safeguard privacy as, after encoding, any print image can no longer be reconstructed.

The electronic card 14 is also designed to run the alphanumeric or graphic display 23 and the keyboard 24 of an active or passive membrane type that might be provided in each peripheral unit 11.

Some standard components provided in the various blacks have been omitted in the drawings, such as memory buffers, feeders, signal amplifiers, connectors and the like as they are components well known to a person skilled in this field.

Numerous variations and modifications can be made to the present invention within the scope thereof.

Thus, for example, instead of using a cable connection it is possible to connect peripheral units 11, interface 17 and the central processor 15 via radio, whereby any wiring would be unnecessary.

As already mentioned above, besides through a USB port, the connection to the central processor 15 can also occur by means of a parallel port on the processor 15 itself. The connection to parallel port can also be combined with the connection to USB port for handling of a greater number of peripheral units 11.

The integrated system 10 according to the invention can be used in a substantially unlimited variety of applications. More particularly, in the case of particularly severe applications where the risk exists of lack of permanent physical connection between the central processor 15 and each peripheral unit 11, one can resort to such a level of peripheral processors (not shown) as to ensure continuity in the service even under extremely unfavourable conditions for remote communications.

Besides for access control, the integrated system 10 is particularly indicated for use in automatic billing dispensing machines, equipment, e.g. for gyms, machines that can be automatically set after users recognition, in releasing locks without the use of keys and so on, in the authorisation of payments, purchases, bank transfers or and the like.

According another modification of the invention, the interface 17 can be integrated in the mother board of a central processor 15, while, according to a further embodiment, the software of the interface 17 and the peripheral units 11 can be updated and altered via network.

1. A user recognition system for automatic managing of accesses, the use of equipment, handling of goods or enjoying of services, including at least one central processor (2, 15), at least one peripheral unit (4, 11) with at least one detecting device (12) for detecting biometric data relating to the physical characteristic features identifying a user, characterised in that each peripheral unit (4, 11) is connected through at least one interface unit (5, 17) to said central processor (2, 15) by means of a communication network, and that each peripheral unit (4, 11) have at least one electronic card (14) suitable for permitting two-way transmission of biometric data acquired from said detection means (12) to said central processor (2, 15), through at least one interface unit (5,17) acting as a network card and interface between a port (19) of said central processor (2, 15) and said communication network.

2. A system according to claim 1, characterised in that the said electronic card (14) comprises at least one portion thereof including Ethernet wiring and at least another portion thereof including a serial wiring.

3. A system according to claim 2, characterized in that a transmission protocol used in said serial wiring portion is a high-speed synchronous serial transmission protocol.

4. A system according to any previous claim, characterized in that the said electronic card (14) comprises at least one communication chip (18) and is suitable for transmitting said data to said at least one central processor (2, 15) through said interface unit (5, 17) at a speed of about 1 Mbps or greater.

5. A system according to claim 4, characterised in that the said communication chip (18) is of RS485 type.

6. A system according to claim 4, characterized in that the said communication chip (18) is of Ethernet type.

7. A system according to claim 5 or 6, characterised in that the said communication chip (18) is designed to create the communication, at a speed of about at least 1 Mbps, between a port (19) on said central processor (2, 15) and at least one of said electronic cards (14) associated with a respective peripheral unit (4, 11).

8. A system according to claim 7, characterised in that the said port (19) is a USB port.

9. A system according to claim 7, characterised in that the said port (19) is a parallel port.

10. A system according to claim 7, characterised in that the said port (19) is an ethernet port.

11. A system according to claim 7, characterised in that the said port (19) is a cunbus port.

12. A system according to claim1, characterised in that the connection between each peripheral unit (4, 11) and said interface unit (5, 17) occurs through radio connection.

13. A system according to claim 12, characterised in that it comprises at least one connection hub (22) suitable for connecting at least two of said interface units (5, 17) to said central processor (2, 15).

14. A system according to claim 13, characterised in that it comprises a plurality of blocks (21) each having a plurality of peripheral units (4, 11) and connected to said central processor (2, 15) through a respective interface unit (5, 17).

15. A system according to claim 1, characterised in that the said electronic card (14) is designed to register at least temporarily said data acquired by said detecting means (12) and to affect on them a compression to obtain a higher transmission speed.

16. A system according to any preceding claim, characterised in that a plurality of said peripheral units (4, 11) are connected to one another in cascade and connected to at least one of said interface units (5, 17).

17. A system according to any preceding claim, characterised in that each of said peripheral units (4, 11) is suitable for sending through said local central processor (2, 15), a piece of the biometric data detected in tcp/ip network to a remote processor and for establishing a two-way data communication therewith.

18. A system according to claim 1 or 9, characterised in that said electronic card (14) is arranged to be connected to an alphanumeric or graphic display (23) and a respective keyboard (24).

19. A system according to any preceding claim, characterised in that at least one of said interface units (5, 17) can be integrated in a mother board of the central processor (2, 15).

20. A system according to any preceding claim, characterised in that said physical characteristic feature of the user is his finger prints and the said detecting means (12) is a finger print recognizer.

21. A system according to any preceding claim 1 to 18, characterised in that said physical characteristic feature of the user is his eye retina and said detecting means (12) is retina recognizer.

22. A system according to any preceding claim 1 to 18, characterised in that said physical characteristic feature of the user is his voice print and said detecting means (12) is a voice recognizer.

23. A system according to any preceding claim 1 to 18, characterised in that said physical characteristic feature of the user are his facial features and said detecting means (12) is a voice recognizer.

24. A system according to any preceding 1 to 18 claims, characterised in that said data acquired by at least one of said peripheral units (4, 11) are stored in compact and encoded form by said central processor (2, 15).

25. A system according to claim 24, characterised in that between the said central processor (2, 15) and said at least one peripheral unit (4, 11) there is provided at least one level of local processors arranged to make up failures in the network connection between the said central processor (2, 15) and said at least one peripheral unit (4, 11).

26. A system according to claim 24, characterized in that the said Ethernet network uses the tcp/ip protocol.

27. A system according to any preceding claim 1 to 25, characterised in that the said communication network is a digital telecommunication network.
